(19) United States
(12) Patent Application Publication
(10) Pub. No.: US 2014/0220885 A1
(43) Pub. Date: Aug. 7, 2014

(54) METHOD FOR ESTABLISHING WIRELESS CONNECTION BETWEEN ELECTRONIC DEVICE AND COMPUTER HOST AND COMPUTER SYSTEM USING SUCH METHOD

(71) Applicant: Primax Electronics Ltd., Taipei (TW)

(72) Inventors: Shu-Wei Chou, Taipei (TW); Chun-Nan Su, Taipei (TW); Chien-Nan Lin, Taipei (TW)

(73) Assignee: Primax Electronics Ltd., Taipei (TW)

(21) Appl. No.: 13/904,900

(22) Filed: May 29, 2013

(30) Foreign Application Priority Data
Feb. 1, 2013 (TW) 102103956

(51) Int. Cl. H04W 4/00

(52) U.S. Cl. CPC H04W 4/008
USPC 455/41.1

(57) ABSTRACT

A method for establishing a wireless connection between an electronic device and a computer host is provided. Firstly, a near field communication between a NFC reader of the computer host and a NFC tag of the electronic device is performed. Then, a Bluetooth wireless communication between the electronic device and the computer host is performed, and the NFC tag is disabled. Consequently, the NFC tag is not repeatedly read by the NFC reader. In other words, the use of the electronic device is more convenient.

### FIELD OF THE INVENTION

The present invention relates to a method for establishing a wireless connection between an electronic device and a computer host, and more particularly to a method for establishing a wireless connection between an electronic device and a computer host by a near field communication technology.

### BACKGROUND OF THE INVENTION

Generally, the widely-used peripheral electronic devices of a computer system include for example a mouse device, a keyboard device, a trackball device, a touchpad, and the like. Among these peripheral electronic devices, the mouse device is the most prevailing because it is very easy-to-use. When a mouse device is held by the user's hand, the mouse device may be intuitively operated to control movement of the cursor shown on the display screen of the computer system. Consequently, the users and the manufacturers of electronic devices pay much attention to the mouse devices.

Hereinafter, the connection between a computer host and an electronic device will be illustrated with reference to FIG. 1. FIG. 1 schematically illustrates the connection between a computer host and an electronic device according to the prior art. The computer system 2 comprises a computer host 21 and a display screen 22. The computer host 21 is in communication with an electronic device 1 and the display screen 22. The computer host 21 has a connecting port 211. A graphic-based window 221 and a cursor 222 are shown on the display screen 22. The electronic device 1 is used for controlling the cursor 222 to have the computer host 21 execute a corresponding command. For example, the electronic device 1 is a mouse device. The electronic device 1 comprises a connecting wire 11 and a connector 12. An end of the connecting wire 11 is connected with the connector 12. Consequently, plural mouse signals may be transmitted from the electronic device 1 through the connecting wire 11. Moreover, after the connector 12 is plugged into the connecting port 211 of the computer host 21, the connection between the electronic device 1 and the computer host 21 is established. Moreover, the connector 12 is a universal series bus (USB) interface for example.

Since the electronic device 1 is connected with the computer host 21 through the connecting wire 11, the operable range for the user is restricted by the length of the connecting wire 11. In other words, the wire linkage is very troublesome and inconvenient to the user. With the maturity of wireless communication technologies, the wireless communication technologies are gradually applied to many electronic devices by the manufacturers of electronic devices. Consequently, the electronic devices can be in communication with the computer system by the wireless communication technologies. For example, the wireless communication technologies include a 2.4G RF (Radio Frequency) wireless communication technology, a 5G RF wireless communication technology, a Bluetooth wireless communication technology, or the like.

For implementing the 2.4G RF wireless communication technology or the 5G RF wireless communication technology, a wireless signal transmitter and a wireless signal receiver are required to perform the wireless transmission. Generally, the wireless signal transmitter is installed in the electronic device. After the wireless signal receiver is plugged into the connecting port of the computer host, the wireless connection between the electronic device and the computer host is established. Moreover, since different settings of the communication protocols of the 2.4G RF wireless communication technology or the 5G RF wireless communication technology are usually adopted by different manufacturers of electronic devices, it is difficult to unify the communication protocols. That is, the wireless signal receivers which are produced by different manufacturers of electronic devices usually fail to be shared by the electronic devices which are produced by other manufacturers.

From the above discussions, the RF wireless communication technology has the above drawbacks. However, since the communication protocols of the Bluetooth wireless communication technology and associated specifications are unified, the Bluetooth wireless communication technology can be applied to various electronic devices that are produced by different manufacturers. Consequently, the Bluetooth wireless communication technology is favored by many electronic companies, and the Bluetooth wireless communication technology is applied to the electronic devices of these electronic companies. However, for establishing the connection between a first electronic device and the computer host or a second electronic device, the first electronic device should firstly search the computer host or the second electronic device. Since the process of searching the computer host or the second electronic device is time-consuming, a certain time period is required to perform the Bluetooth wireless transmission.

Since the searching time period of the Bluetooth wireless communication technology is long, a novel Microsoft Windows 8 operating system adopts a built-in near field communication (NFC) technology. The near field communication technology can replace the pairing process of the Bluetooth wireless communication technology in order to reduce the time period of using the Bluetooth wireless communication technology to establish the connection between the Bluetooth devices. First of all, the hardware components for implementing the near field communication technology will be illustrated as follows. The electronic device comprises a near field communication (NFC) tag and a first Bluetooth wireless communication module. The computer host of the computer system comprises a near field communication (NFC) reader and a second Bluetooth wireless communication module. When the NFC tag is located near the NFC reader or contacted with the NFC reader, the NFC tag can be read by the NFC reader. Consequently, the near field communication between the computer host and the electronic device is established.

For establishing the wireless connection between the electronic device and the computer host which is executed under the Windows 8 operating system, the user may firstly move the electronic device to a position near the computer host. Consequently, the NFC tag is detected by the NFC reader of the computer host. After the NFC tag is detected, the NFC reader issues a request packet to the NFC tag. According to the request packet, the NFC tag issues an electronic device identification data to the NFC reader. The electronic device identification data contains an OOB (Out of Band) data length, a Bluetooth device address and an OOB option data. When the electronic device identification data is received by the computer host, the electronic device is identified by the computer host according to the Bluetooth device address, and a connection dialog box is shown on a display screen of the computer system. An electronic device name corresponding to the electronic device identification data is displayed on the connection dialog box. If the user judges that the electronic device name is related to the electronic device, the user may input a confirmation signal to the computer host. Then, the second Bluetooth wireless communication module is activated by the computer host. Consequently, the wireless connection between the second Bluetooth wireless communication module and the first Bluetooth wireless communication module is established according to the Bluetooth device address. Under this circumstance, the Bluetooth wireless connection between the computer host and the electronic device is established. From the above discussions, since the computer system utilizes the near field communication technology to replace the searching process of the Bluetooth wireless communication technology, the time period for completing the connection of the Bluetooth wireless communication is shortened.

However, the near field communication technology under the Windows 8 operating system still has some drawbacks. For example, after the Bluetooth wireless connection between the computer host and the electronic device is established, if the electronic device is accidentally placed at the position near the computer host during operations of the electronic device, the NFC tag is detected by the NFC reader of the computer host again. After the NFC tag is detected, the NFC reader issues the request packet to the NFC tag again. According to the request packet, the NFC tag issues the electronic device identification data to the NFC reader again. Consequently, the near field communication is performed again. That is, as long as the electronic device is placed at the position near the computer host, regardless of whether the electronic device and the computer host have been in wireless communication with each other, the near field communication between the electronic device and the computer host under the Windows 8 operating system is repeatedly performed. Since the connection dialog box displayed on the display screen may force the user to interrupt the operations of the electronic device, the conventional wireless connection method is inconvenient.

Therefore, there is a need of providing a computer system and a method for establishing wireless connection between an electronic device and a computer host in order to avoid repeatedly performing the near field communication.

### SUMMARY OF THE INVENTION

The present invention provides a method for establishing wireless connection between an electronic device and a computer host in order to avoid repeatedly performing the near field communication.

The present invention also provides a computer system for avoiding repeatedly performing the near field communication.

In accordance with an aspect of the present invention, there is provided a method for establishing a wireless connection between an electronic device and a computer host. The electronic device includes a NFC tag. The computer host includes a NFC reader. The method includes the following steps. Firstly, the computer host judges whether the NFC tag is read by the NFC reader. Then, the computer host performs a near field communication technology to establish a wireless connection between the NFC reader and the NFC tag, and judges whether the electronic device is identified. Then, the computer host performs a Bluetooth wireless communication technology to establish the wireless connection between the electronic device and the computer host. Afterwards, the electronic device disables the NFC tag, thereby interrupting the wireless connection between the NFC reader and the NFC tag.

In accordance with another aspect of the present invention, there is provided a computer system. The computer system includes an electronic device and a computer host. The electronic device includes a first Bluetooth wireless communication module and a near field communication circuit. The first Bluetooth wireless communication module is disposed within the electronic device. The near field communication circuit is disposed within the electronic device, and includes a NFC tag, a cut-off circuit and a controlling unit. The NFC tag issues an electronic device identification data. The cut-off circuit is connected with the NFC tag for disabling the NFC tag. The controlling unit is connected with the NFC tag and the cut-off circuit for activating the first Bluetooth wireless communication module or controlling the cut-off circuit to disable the NFC tag. The computer host includes a NFC reader and a second Bluetooth wireless communication module. The NFC reader is disposed within the computer host or connected with the computer host. When the NFC tag is read by the NFC reader, the electronic device identification data from the NFC tag is received by the NFC reader. The second Bluetooth wireless communication module is disposed within the computer host. A wireless connection between the first Bluetooth wireless communication module and the second Bluetooth wireless communication module is established according to the electronic device identification data.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the connection between a computer host and an electronic device according to the prior art;

FIG. 2 schematically illustrates the outer appearance of a computer system using a method for establishing a wireless connection between an electronic device and a computer host according to an embodiment of the present invention;

FIG. 3 is a schematic functional block diagram illustrating the computer system according to the embodiment of the present invention;

FIG. 4 is a schematic perspective view illustrating the outer appearance of an electronic device of the computer system according to the embodiment of the present invention and taken along another viewpoint;

FIG. 5 is a schematic circuit diagram illustrating the near field communication circuit of the computer system according to the embodiment of the present invention; and

FIG. 6 is a flowchart illustrating a method for establishing the wireless connection between an electronic device and a computer host according to an embodiment of the present invention.

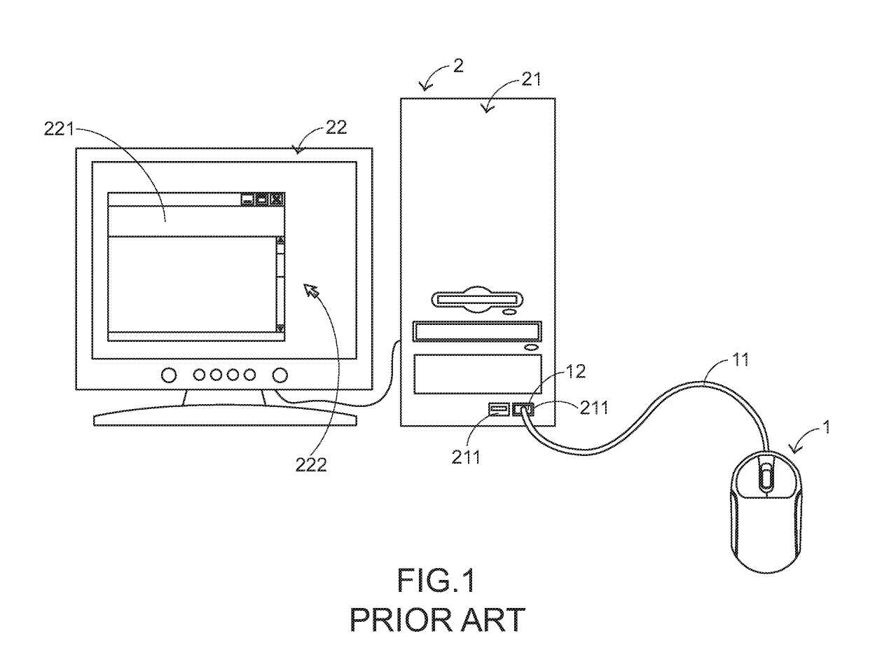

### DETAILED DESCRIPTION OF THE PREFERRED EMBODIMENT

For eliminating the drawbacks encountered from the prior art, the present invention provides a method for establishing a wireless connection between an electronic device and a computer host.

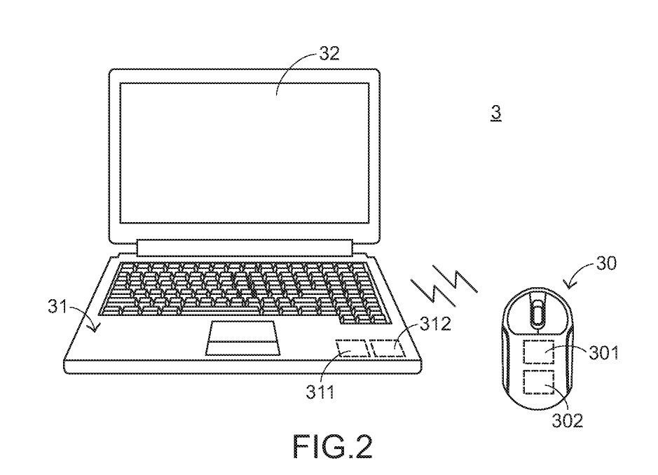

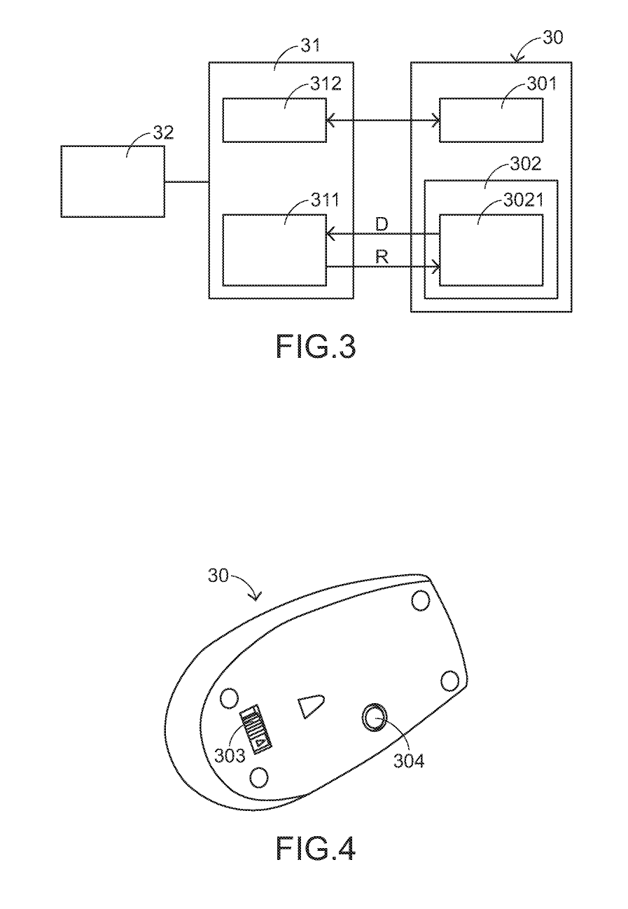

First of all, the outer appearance of a computer system using the method of the present invention will be illustrated as follows. FIG. 2 schematically illustrates the outer appearance of a computer system using a method for establishing a wireless connection between an electronic device and a computer host according to an embodiment of the present invention. FIG. 3 is a schematic functional block diagram illustrating the computer system according to the embodiment of the present invention. FIG. 4 is a schematic perspective view illustrating the outer appearance of an electronic device of the computer system according to the embodiment of the present invention and taken along another viewpoint. Please refer to FIGS. 2, 3 and 4. The computer system 3 comprises an electronic device 30, a computer host 31, and a display screen 32. The electronic device 30 comprises a first Bluetooth wireless communication module 301, a near field communication circuit 302, a power source (not shown), a power switch 303, and a pairing button 304. The first Bluetooth wireless communication module 301 is disposed within the electronic device 30. The near field communication circuit 302 is also disposed within the electronic device 30. The power source is disposed within the electronic device 30 for providing electric power to the first Bluetooth wireless communication module 301 and the near field communication circuit 302. The power switch 303 is located at a bottom side of the electronic device 30, and connected with the near field communication circuit 302 and the power source. By operating the power switch 303, the power source can be turned off and the electronic device 30 can be turned off. The pairing button 304 is located at the bottom side of the electronic device 30, and connected with the first Bluetooth wireless communication module 301. When the pairing button 304 is depressed, the first Bluetooth wireless communication module 301 is activated.

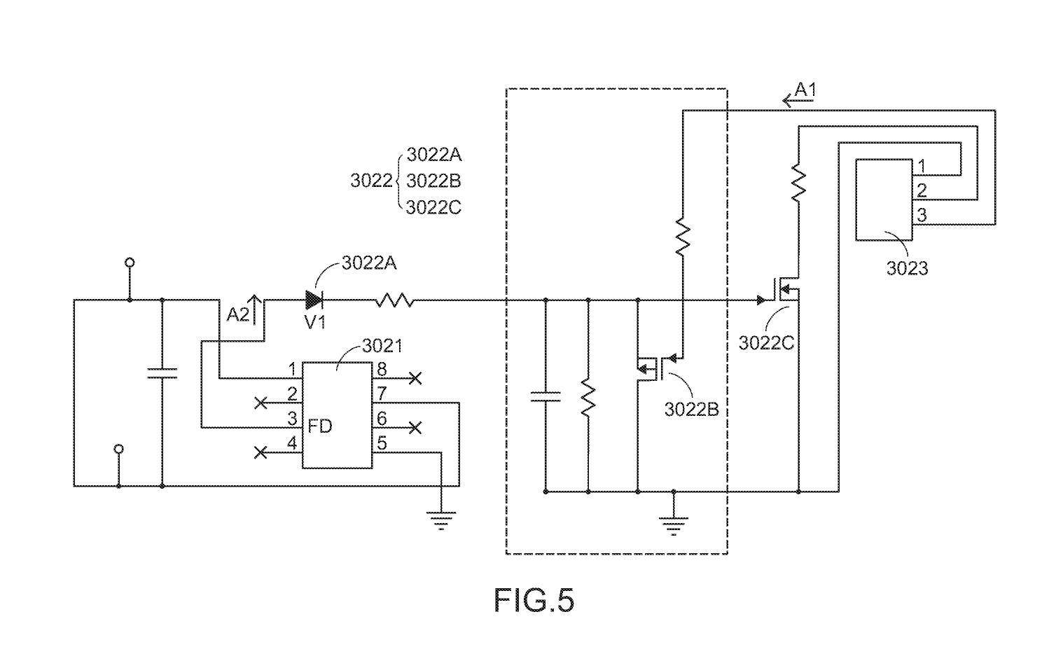

FIG. 5 is a schematic circuit diagram illustrating the near field communication circuit of the computer system according to the embodiment of the present invention. Please refer to FIGS. 2 and 5. The near field communication circuit 302 comprises a NFC tag 3021, a cut-off circuit 3022, and a controlling unit 3023. The NFC tag 3021 is disposed within the electronic device 30 for issuing an electronic device identification data D (see FIG. 3). The cut-off circuit 3022 is connected with the NFC tag 3021 for disabling the NFC tag 3021. The controlling unit 3023 is connected with the NFC tag 3021 and the cut-off circuit 3022 for activating the first Bluetooth wireless communication module 301 or controlling the cut-off circuit 3022 to disable the NFC tag 3021. In this embodiment, the electronic device identification data D contains an OOB (Out of Band) data length, a Bluetooth device address and an OOB option data. The controlling unit 3023 is installed in the electronic device 30 in a form of firmware. The components and operations of the cut-off circuit 3022 will be illustrated in more details later.

The computer host 31 is connected with the display screen 32. The computer host 31 comprises a NFC reader 311 and a second Bluetooth wireless communication module 312. The NFC reader 311 is disposed within the computer host 31. When the NFC tag 3021 is read by the NFC reader 311, the electronic device identification data D from the NFC tag 3021 is received by the NFC reader 311. The second Bluetooth wireless communication module 312 is disposed within the computer host 31. According to the electronic device identification data D, a wireless connection between the first Bluetooth wireless communication module 301 and the second Bluetooth wireless communication module 312 is established. In this embodiment, the computer host 31 and the display screen 32 are collaboratively defined as a notebook computer, and the electronic device is a wireless mouse device. Alternatively, in some other embodiments, the computer host and the display screen may be collaboratively defined as a smart phone or a tablet personal computer. Moreover, the NFC reader may be externally connected with the computer host. Moreover, the electronic device may be a wireless keyboard device.

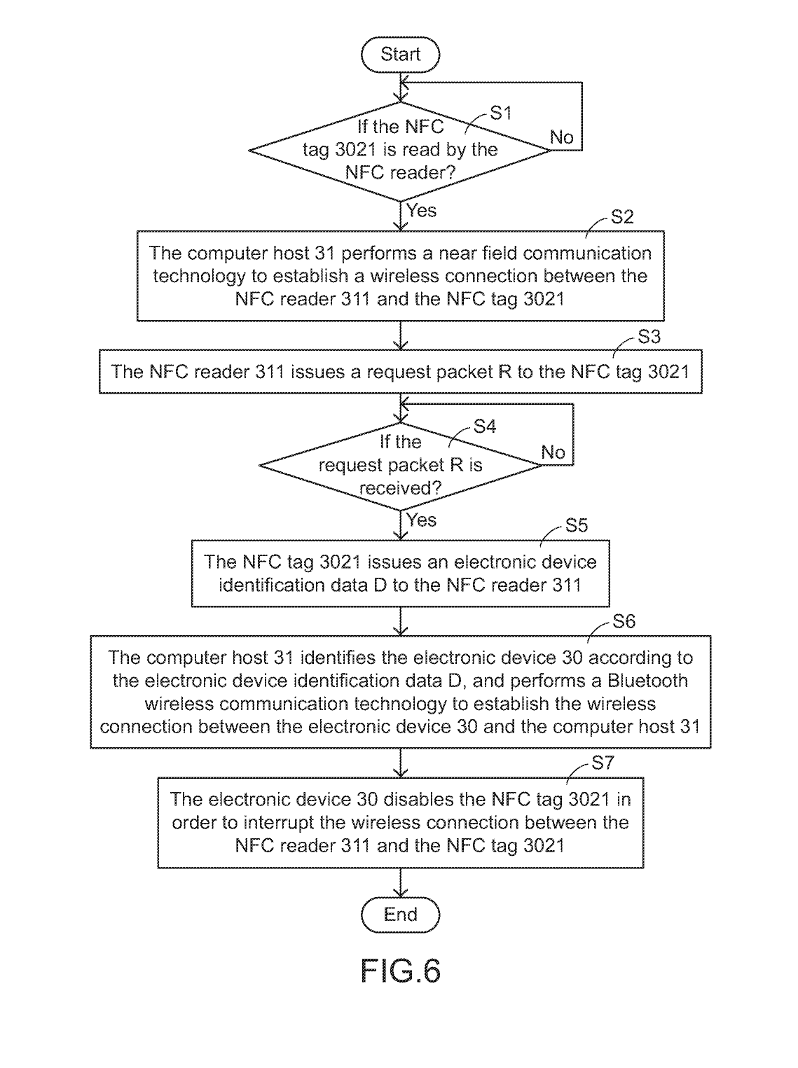

Hereinafter, a method for establishing the wireless connection between an electronic device and a computer host will be illustrated will be illustrated with reference to FIG. 6. FIG. 6 is a flowchart illustrating a method for establishing the wireless connection between an electronic device and a computer host according to an embodiment of the present invention. The method includes the following steps. Firstly, in the step S1, the computer host 31 judges whether the NFC tag 3021 is read by the NFC reader 311. In step S2, the computer host 31 performs a near field communication technology to establish a wireless connection between the NFC reader 311 and the NFC tag 3021. In step S3, the NFC reader 311 issues a request packet R (see FIG. 3) to the NFC tag 3021. In step S4, the NFC tag 3021 judges whether the request packet R is received. In step S5, the NFC tag 3021 issues an electronic device identification data D to the NFC reader 311. In the step S6, the computer host 31 identifies the electronic device 30 according to the electronic device identification data D, and performs a Bluetooth wireless communication technology to establish the wireless connection between the electronic device 30 and the computer host 31. In the step S7, the electronic device 30 disables the NFC tag 3021, thereby interrupting the wireless connection between the NFC reader 311 and the NFC tag 3021.

In the step S1 of the method of the present invention, if the computer host 31 judges that the NFC tag 3021 is read by the NFC reader 311, the step S2 is performed. On the other hand, if the computer host 31 judges that the NFC tag 3021 is not read by the NFC reader 311, the step S1 is performed again. In the step S4, if the NFC tag 3021 judges that the request packet R is received, the step S5 is performed. On the other hand, if the NFC tag 3021 judges that the request packet R is not received, after a predetermined time period, the step S4 is performed again.

Hereinafter, the circuitry layout and the operation of the near field communication circuit 302 will be illustrated with reference to FIG. 5 again. As shown in FIG. 5, the cut-off circuit 3022 of the near field communication circuit 302 comprises a diode 3022A, a switching circuit 3022B, and an inverter 3022C. The diode 3022A is connected with the NFC tag 3021 for providing a forward bias voltage V1. The switching circuit 3022B is connected with the diode 3022A and the controlling unit 3023. When an off signal Al from the controlling unit 3023 is received by the switching circuit 3022B, the switching circuit 3022B is short-circuited and connected to ground. Under this circumstance, since the NFC tag 3021 is connected to ground, the NFC tag 3021 is disabled. The inverter 3022C is connected with the diode 3022A and the controlling unit 3023. If an output signal A2 from the NFC tag 3021 is higher than the forward bias voltage V1, the output signal A2 is converted into a low logic-level signal by the inverter 3022C. Whereas, if the output signal A2 from the NFC tag 3021 is lower than the forward bias voltage V1, the forward bias voltage V1 is converted into a high logic-level signal by the inverter 3022C. In addition, the low logic-level signal or the high logic-level signal is transmitted from the inverter 3022C to the controlling unit 3023. When the low logic-level signal is received by the controlling unit 3023, the first Bluetooth wireless communication module 301 is activated, and the off signal Al is issued to the switching circuit 3022B. In response to the off signal Al, the switching circuit 3022B is short-circuited and connected to ground. Consequently, the NFC tag 3021 is disabled. On the other hand, when the high logic-level signal is received by the controlling unit 3023, the NFC tag 3021 is normally operated.

Alternatively, in another embodiment, the cut-off circuit only comprises a diode and a switching circuit. That is, the inverter is not included in the cut-off circuit, and the settings of the controlling unit are correspondingly adjusted. If an output signal from the NFC tag is higher than the forward bias voltage, the output signal is a high logic-level signal. In addition, the high logic-level signal is transmitted to the controlling unit. When the high logic-level signal is received by the controlling unit, the first Bluetooth wireless communication module is activated, and the off signal is issued to the switching circuit. In response to the off signal, the switching circuit is short-circuited and connected to ground. Consequently, the NFC tag is disabled.

The operations of the method for establishing the wireless connection between the electronic device and the computer host will be illustrated in more details as follows. Please refer to FIGS. 2, 3, 4 and 6 again. Firstly, the computer system 3 is in an initial state. In the initial state, the near field communication and the Bluetooth wireless connection between the computer host 31 and the electronic device 30 have not been established. At this time, the computer host 31 is operated to judge whether the NFC tag 3021 is read by the NFC reader 311 (i.e. the step S1). Since the electronic device 30 is not located near the computer host 31, the NFC tag 3021 is not read by the NFC reader 311 of the computer host 31. Moreover, the computer host 31 judges again whether the NFC tag 3021 is read by NFC reader 311.

When the user wants to use the electronic device 30 to operate the computer host 31, the electronic device 30 is moved to a position near the computer host 31. Meanwhile, the computer host 31 judges again whether the NFC tag 3021 is read by the NFC reader 311 (i.e. the step S1). Since the closeness between the electronic device 30 and the computer host 31 is sufficient to allow the NFC reader 311 to read the NFC tag 3021, the computer host 31 will perform a near field communication technology to establish the wireless connection between the NFC reader 311 and the NFC tag 3021 (i.e. the step S2).

After the wireless connection between the NFC reader 311 and the NFC tag 3021 is established, the NFC reader 311 issues the request packet R to the NFC tag 3021 (i.e. the step S3). Then, the NFC tag 3021 judges whether the request packet R from the NFC reader 311 is received (i.e. the step S4). If the NFC tag 3021 judges that the request packet R is received, the NFC tag 3021 issues an electronic device identification data D to the NFC reader 311 (i.e. the step S5). On the other hand, if the NFC tag 3021 judges that the request packet R is not received, no action is done by the NFC tag 3021 and the electronic device identification data D is not issued to the NFC reader 311. If the electronic device identification data D is not received by the NFC reader 311 within the predetermined time period, the NFC reader 311 judges that the request packet R is not received by the NFC tag 3021. Meanwhile, the NFC reader 311 issues the request packet R to the NFC tag 3021 again. That is, the step S3 is performed again.

After the electronic device identification data D is received by the NFC reader 311, the computer host 31 identifies the electronic device 30 according to the electronic device identification data D. In addition, the second Bluetooth wireless communication module 312 is activated by the computer host 31. Consequently, the wireless connection between the second Bluetooth wireless communication module 312 and the first Bluetooth wireless communication module 301 of the electronic device 30 is established by a Bluetooth wireless communication technology. Under this circumstance, the wireless connection between the electronic device 30 and the computer host 31 is established (i.e. the step S6). Since the wireless connection between the first Bluetooth wireless communication module 301 and the second Bluetooth wireless communication module 312 is established, the cut-off circuit 3022 of the electronic device 30 will disable the NFC tag 3021. Under this circumstance, the wireless connection between the NFC reader 311 and the NFC tag 3021 is interrupted (i.e. the step S7). Meanwhile, between the electronic device 30 and the computer host 31, only the wireless connection between the first Bluetooth wireless communication module 301 and the second Bluetooth wireless communication module 312 is still maintained. Consequently, the user can operate the electronic device 30 or move the electronic device 30 at will. Since the NFC tag 3021 is disabled, even if the electronic device 30 is located near the computer host 31 again, the NFC tag 3021 fails to be read by the NFC reader 311. In other words, the wireless connection between the NFC reader 311 and the NFC tag 3021 is not established.

It is noted that the computer host 31 identifies the electronic device 30 according to the electronic device identification data D. Moreover, after the electronic device 30 is identified, the second Bluetooth wireless communication module 312 is activated by the computer host 31. The process of activating the first Bluetooth wireless communication module 301 of the electronic device 30 will be illustrated as follows. Please refer to FIGS. 4 and 5 again. When the NFC tag 3021 issues the electronic device identification data D to the NFC reader 311, a third pin FD of the NFC tag 3021 issues the output signal A2. The output signal A2 is a high logic-level signal. Since the output signal A2 is higher than the forward bias voltage V1, the output signal A2 is transferred through the inverter 3022C. By the inverter 3022C, the output signal A2 in the high logic-level state (i.e. the high logic-level signal) is converted into the output signal A2 in a low logic-level state (i.e. a low logic-level signal). In addition, the low logic-level signal is transmitted to the controlling unit 3023. When the low logic-level signal is received by the controlling unit 3023, the first Bluetooth wireless communication module 301 is activated, and the off signal Al is issued to the switching circuit 3022B. In response to the off signal Al, the switching circuit 3022B is short-circuited and connected to ground. That is, since the third pin FD of the NFC tag 3021 is connected to ground, the NFC tag 3021 is disabled, and the NFC tag 3021 fails to be read by the NFC reader 311.

Since the NFC tag 3021 is disabled and fails to be normally operated, if the user wants to establish the Bluetooth wireless connection between the electronic device 30 and an additional computer host (not shown), two approaches may be used to establish the Bluetooth wireless connection between these two devices. In accordance with a first approach, the user may operate the power switch 303 of the electronic device 30 to turn off the power source of the electronic device 30. Consequently, the controlling unit 3023 is turned off. Then, the user may operate the power switch 303 again to turn on the power source. Consequently, the controlling unit 3023 is turned on again, and the NFC tag 3021 is enabled. When the electronic device 30 is located near the additional computer host, the NFC tag 3021 is read by an additional NFC reader of the additional computer host. Consequently, the wireless connection between the additional NFC reader and the NFC tag 3021 is established. Moreover, the Bluetooth wireless communication module of the additional computer host and the first Bluetooth wireless communication module 301 of the electronic device 30 are activated. Consequently, the Bluetooth wireless communication between these two Bluetooth wireless communication modules is established.

In accordance with a second approach, the user may depress the pairing button 304 of the electronic device 30 to activate the first Bluetooth wireless communication module 301 of the electronic device 30. Consequently, the first Bluetooth wireless communication module 301 may search the Bluetooth wireless communication module of the additional computer host in order to perform the Bluetooth wireless communication technology. That is, the use of the conventional Bluetooth wireless communication technology may take a longer searching time period. However, if the NFC reader 311 or the NFC tag 3021 has a breakdown, the Bluetooth wireless communication between the electronic device 30 and the computer host 31 can be still maintained.

From the above descriptions, the present invention provides a method for establishing the wireless connection between an electronic device and a computer host and a computer system using this method. After the wireless connection between the NFC reader and the NFC tag is established, the NFC tag is disabled. Consequently, the NFC tag is not repeatedly read by the NFC reader. Since the operations of the electronic device are not interrupted, the method of the present invention is more user-friendly.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for establishing a wireless connection between an electronic device and a computer host, said electronic device comprising a NFC tag, said computer host comprising a NFC reader, said method comprising steps of:
said computer host judging whether said NFC tag is read by said NFC reader;
said computer host performing a near field communication technology to establish a wireless connection between said NFC reader and said NFC tag, and judging whether said electronic device is identified;
said computer host performing a Bluetooth wireless communication technology to establish said wireless connection between said electronic device and said computer host; and
said electronic device disabling said NFC tag, thereby interrupting said wireless connection between said NFC reader and said NFC tag.

2. The method according to claim 1, wherein if said computer host judges that said NFC tag is read by said NFC reader, said computer host performs said near field communication technology to establish said wireless connection between said NFC reader and said NFC tag, wherein if said computer host judges that said NFC tag is not read by said NFC reader, said computer host judges again whether said NFC tag is read by said NFC reader.

3. The method according to claim 1, wherein said step of judging whether said electronic device is identified comprises sub-steps of:
issuing a request packet from said NFC reader to said NFC tag;
said NFC tag judging whether said request packet is received; and
if said NFC tag judges that said request packet is received, said NFC tag issuing an electronic device identification data to said NFC reader, so that said computer host identifies said electronic device according to said electronic device identification data.

4. The method according to claim 3, wherein said Bluetooth wireless communication technology is performed by said computer host according to said electronic device identification data, so that said wireless connection between said electronic device and said computer host is established.

5. The method according to claim 3, wherein by allowing said NFC tag to be connected to ground, said electronic device disables said NFC tag, so that said wireless connection between said NFC reader and said NFC tag is interrupted and said request packet is not transmitted from said NFC reader to said NFC tag.

6. The method according to claim 1, wherein by allowing said NFC tag to be connected to ground, said electronic device disables said NFC tag, so that said wireless connection between said NFC reader and said NFC tag is interrupted.

7. A computer system, comprising:
an electronic device comprising:
a first Bluetooth wireless communication module disposed within said electronic device; and
a near field communication circuit disposed within said electronic device, and comprising a NFC tag, a cut-off circuit and a controlling unit, wherein said NFC tag issues an electronic device identification data, said cut-off circuit is connected with said NFC tag for disabling said NFC tag, and said controlling unit is connected with said NFC tag and said cut-off circuit for activating said first Bluetooth wireless communication module or controlling said cut-off circuit to disable said NFC tag; and
a computer host comprising:
a NFC reader disposed within said computer host or connected with said computer host, wherein when said NFC tag is read by said NFC reader, said electronic device identification data from said NFC tag is received by said NFC reader; and
a second Bluetooth wireless communication module disposed within said computer host, wherein a wireless connection between said first Bluetooth wireless communication module and said second Bluetooth wireless communication module is established according to said electronic device identification data.

8. The computer system according to claim 7, wherein when said NFC tag is read by said NFC reader, said NFC reader issues a request packet to said NFC tag, wherein said NFC tag issues said electronic device identification data to said NFC reader according to said request packet.

9. The computer system according to claim 7, wherein said cut-off circuit comprises:
a diode connected with said NFC tag for providing a forward bias voltage;
a switching circuit connected with said diode and said controlling unit, wherein when an off signal from said controlling unit is received by said switching circuit, said switching circuit is short-circuited and connected to ground, so that said NFC tag is connected to ground and disabled; and
an inverter connected with said diode and said controlling unit, wherein if an output signal from said NFC tag is higher than said forward bias voltage, said output signal is converted into a low logic-level signal by said inverter, and said low logic-level signal is transmitted to said controlling unit.

10. The computer system according to claim 9, wherein when said low logic-level signal is received by said controlling unit, said first Bluetooth wireless communication module is activated, and said off signal is issued to said switching circuit to disable said NFC tag.

11. The computer system according to claim 7, wherein said cut-off circuit comprises:
a diode connected with said NFC tag for providing a forward bias voltage; and
a switching circuit connected with said diode and said controlling unit, wherein when an off signal from said controlling unit is received by said switching circuit, said switching circuit is short-circuited and connected to ground, so that said NFC tag is connected to ground and disabled, wherein if an output signal from said NFC tag is higher than said forward bias voltage, said output signal is a high logic-level signal, and said high logic-level signal is transmitted to said controlling unit.

12. The computer system according to claim 11, wherein when said high logic-level signal is received by said controlling unit, said first Bluetooth wireless communication module is activated, and said off signal is issued to said switching circuit to disable said NFC tag.

13. The computer system according to claim 7, wherein said electronic device further comprises a pairing button, and said pairing button is connected with said first Bluetooth wireless communication module, wherein when said pairing button is depressed, said first Bluetooth wireless communication module is activated, and said wireless connection between said first Bluetooth wireless communication module and said second Bluetooth wireless communication module is established.

14. The computer system according to claim 7, wherein said electronic device further comprises a power switch, and said power switch is connected with said near field communication circuit and a power source for turning off said power source and turning off said electronic device, wherein after said turned-off power source is turned on again, said disabled NFC tag is enabled again.
